(19) United States
(12) Patent Application Publication
(10) Pub. No.: US 2013/0015752 A1
(43) Pub. Date: Jan. 17, 2013

(54) ROTATABLE POWER-PLANT CASE SECTION

(71) Applicant: Mustafa Gerengi, Gebze (TR)

(72) Inventor: Mustafa Gerengi, Gebze (TR)

(73) Assignee: GENERAL ELECTRIC COMPANY, Schenectady, NY (US)

(21) Appl. No.: 13/487,489

(22) Filed: Jun. 4, 2012

(30) Foreign Application Priority Data
Jul. 15, 2011 (TR) 201107015

(51) Int. Cl. F16M 1/04; B23P 19/00

(52) U.S. Cl. 312/237; 29/426.5

(57) ABSTRACT

A rotatable power-plant case section comprises a web disposed between a first flange and a second flange. At least one rotary strut and at least one fixed support strut are attached to the first flange. The case section includes at least one lifting connector for applying a force to raise the rotatable power-plant case section and at least one rotating connector for applying a force to rotate the case section.

A method for rotating a power-plant case section comprises attaching at least one rotary strut, at least one fixed support strut, at least one lifting connector, and at least one rotating connector to a power-plant case section, applying a force to the lifting connector so as to raise the case section, and applying a force to the rotating connector so as to rotate the case section to a desired orientation.

### CROSS REFERENCE TO RELATED APPLICATIONS

This application claims priority to Turkish Patent Application No. 2011/07015 filed on Jul. 15, 2011, the entire contents of which are hereby incorporated by reference herein.

### BACKGROUND OF THE INVENTION

The subject matter disclosed herein relates generally to power generating gas turbines and, more specifically, to a rotatable case section for a power generating gas turbine.

Gas turbines used for ground-based power generation (i.e., in power-plants) often employ case assemblies to provide a supporting structure for rotating turbo-machinery and other components, to define a path of flow for the working fluid, and/or to contain turbo-machinery components that might otherwise be released in the event of a failure. Such case assemblies are often divided into annular segments distributed along a central, longitudinal axis of the power-plant. Such use of segmented cases facilitates access to blades, nozzles, shrouds and other turbo-machinery for inspection, maintenance, repair and replacement. Therefore, each individual case segment is typically associated with, and positioned to provide access to, a specific turbo-machinery component such as a compressor, a combustor, or a turbine.

In addition, each annular case segment may be split across its circumferential direction (i.e., split along a direction parallel to a longitudinal axis of the turbo-machine) so as to form two or more semi-annular parts of a case segment (i.e., two or more case sections), each case section providing access to a portion of a turbo-machinery component or another aspect of the power-plant. Semi-annular power-plant case sections are typically joined together by longitudinal flanges to form assembled annular case segments, and assembled case segments are typically joined by circumferential flanges to form a power-plant case assembly.

When repair or maintenance becomes necessary, the power-plant and its turbo-machinery is shut down, and case segments are removed to provide the necessary access. In large power generating installations, case segments and case sections can be extremely large, heavy, and cumbersome, rendering them difficult, dangerous, labor-intensive, and time-consuming to manipulate. Once removed, these very large case structures can also be unstable due to their semi-circular (i.e., semi-annular) shapes.

As a result, those skilled in the art seek improved systems and methods for moving and stabilizing power-plant case segments and case sections.

### BRIEF DESCRIPTION OF THE INVENTION

According to one aspect of the invention, a rotatable power-plant case section comprises a web disposed between a first flange and a second flange. According to the invention, at least one rotary strut and at least one fixed support strut are attached to the first flange. The case section includes at least one lifting connector for applying a force to raise the rotatable power-plant case section and at least one rotating connector for applying a force to rotate the rotatable power-plant case section.

According to another aspect of the invention, a method for rotating a power-plant case section comprises attaching at least one rotary strut, at least one fixed support strut, at least one lifting connector, and at least one rotating connector to a power-plant case section. According to the method, a lifting force is applied to the lifting connector so as to raise the case section, and a rotating force is applied to the rotating connector so as to rotate the case section to a desired orientation.

Accordingly, an improved system and method for moving and stabilizing power-plant case segments and case sections is provided. These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a drawing of an exemplary rotatable power-plant case section as is described herein;

FIG. 2 is a drawing of an exemplary rotary strut as described herein;

FIG. 3 is a drawing of an exemplary rotating connector as described herein;

FIG. 4 is a drawing of an exemplary fixed support strut as described herein;

FIG. 5 is a drawing of an exemplary stabilizer as described herein;

FIG. 6 is a drawing of an exemplary lifting connector as described herein;

FIG. 7 is an exemplary rotatable power-plant case section in a horizontal orientation as is described herein;

FIG. 8 is an exemplary rotatable power-plant case section in a horizontal orientation as is described herein;

FIG. 9 is an exemplary rotatable power-plant case section in a horizontal orientation as is described herein; and

FIG. 10 is an exemplary rotatable power-plant case section in a vertical orientation as is described herein.

The detailed description explains embodiments of the invention, together with advantages and features, by way of example with reference to the drawings.

### DETAILED DESCRIPTION OF THE INVENTION

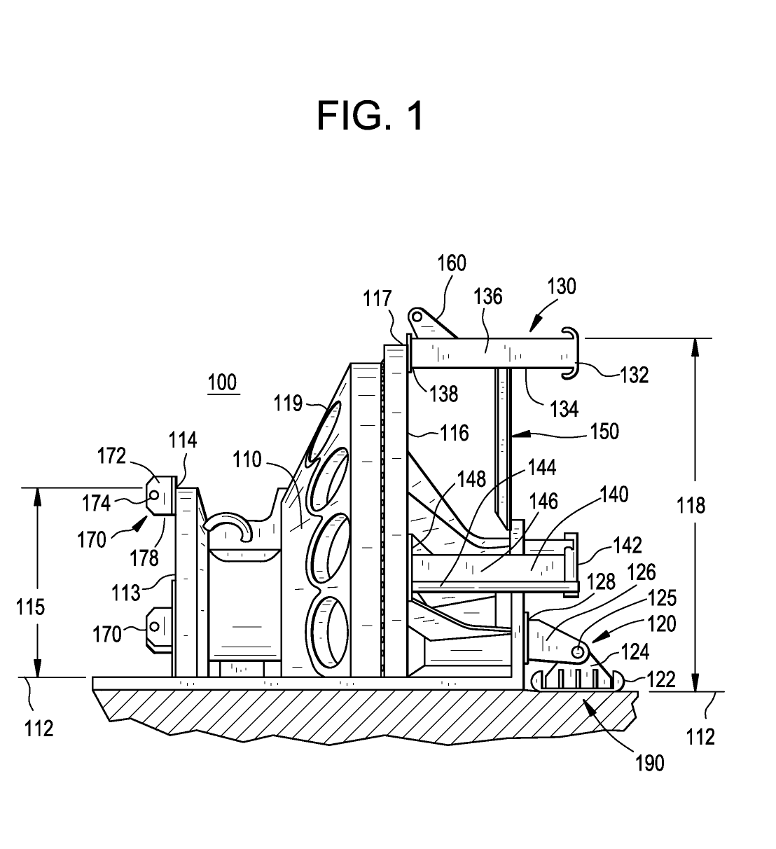

Referring now to the drawings, in which like numerals refer to like elements throughout the several views, FIG. 1 shows an exemplary rotatable power-plant case section 100 as described herein. As shown in FIG. 1, a power-plant case section 110 has been removed from a power-plant (not shown) and is lying on a side 111 such that a central axis 112 of power-plant case section 110 is in a substantially horizontal orientation with its concave interior (not shown) facing downward toward a supporting surface 190. Power-plant case section 110 includes a web 119 disposed between a first flange 116 and a second flange 113, both flanges being configured to cooperate with mating flanges of adjacent power-plant case segments (not shown) to facilitate formation of a power-plant case assembly. Web 119 is semi-annular in shape so as to extend circumferentially around central axis 112 and may be joined to flanges 113, 116 by any suitable means such as welding, forging, or use of mechanical fasteners, for example.

In the orientation depicted in FIG. 1, first flange 116 and second flange 113 both traverse arcs whose end points are proximate supporting surface 190, which may be the ground or a floor or, if desired, a transportable support structure such as a pallet, for example. In this orientation, midpoint 114 of second flange 113 lies above supporting surface 190 by a distance approximately equal to height 115. Similarly, midpoint 117 of first flange 116 lies above supporting surface 190 by a distance approximately equal to height 118.

Rotary strut 120 is attached to first flange 116 using bolts or other suitable fasteners in a position and orientation that enables rotary strut foot 122 to contact and align with supporting surface 190. As shown in FIG. 1, rotary strut 120 includes a rotary strut base 124 and a rotary strut leg 126 that are attached to one another by rotary strut pin 125 so that rotary strut leg 126 may rotate about rotary strut pin 125. Rotary strut base 124 is attached to, and supported by, rotary strut foot 122. Rotary strut leg 126 includes a rotary strut flange 128 to facilitate attachment of rotary strut 120 to first flange 116. In use, rotary strut foot 122 and attached rotary strut base 124 remain substantially stationary with respect to supporting surface 190 while rotary strut leg 126 and attached power-plant case section 110 may rotate about rotary strut pin 125. An additional rotary strut (not shown) is also attached to first flange 116 at an opposing end (not shown) of its arc so that its rotary strut foot also contacts supporting surface 190. This additional rotary strut is positioned and oriented so as to enable its rotary strut foot 122 to contact and align with supporting surface 190 while its rotary strut pin 125 is substantially parallel to the rotary strut pin 125 of the other rotary strut 120.

In an exemplary embodiment, rotatable power-plant case section 100 also includes a fixed support strut 130 that extends in a direction substantially parallel to central axis 112 of power-plant case section 110 from first flange 116 at or near its midpoint 117. In an alternative embodiment rotatable power-plant case section 100 may include a plurality of struts similar to fixed support strut 130 that extends from first flange 116 at points distributed on either side of midpoint 117. At a first end, fixed support strut 130 includes a fixed support strut flange 138 to facilitate attachment of fixed support strut 130 to first flange 116. At an opposing end, fixed support strut 130 includes fixed support strut foot 132. Between fixed support strut foot 132 and fixed support strut flange 138, fixed support strut 130 includes fixed support strut leg 136 and fixed support strut stiffener 134, which are configured to support power-plant case section 110 when rotatable power-plant case section 100 is fully rotated about rotary strut pins 125. The relationship between the lengths of rotary strut 120 and fixed support strut 130 are such that central axis 112 of power-plant case section 110 is in a substantially vertical orientation when both rotary strut foot 122 and fixed support strut foot 132 contact supporting surface 190.

In an exemplary embodiment, rotatable power-plant case section 100 also includes one or more secondary strut 140 for distributing stress from the weight of rotatable power-plant case section 100 around first flange 116 and for stabilizing rotatable power-plant case section 100 in its fully rotated orientation with its central axis 112 oriented vertically. Similar to fixed support strut 130, secondary strut 140 extends in a direction substantially parallel to central axis 112 of power-plant case section 110 from first flange 116. At a first end, secondary strut 140 includes a secondary strut flange 148 to facilitate attachment of secondary strut 140 to first flange 116. At an opposing end, secondary strut 140 includes secondary strut foot 142. Between secondary strut foot 142 and secondary strut flange 148, secondary strut 140 includes secondary strut leg 146 and secondary strut stiffener 144, which are configured to help support power-plant case section 110 when rotatable power-plant case section 100 is fully rotated about rotary strut pins 125. In an exemplary embodiment, the relationship between the lengths of secondary strut 140, fixed support strut 130, and rotary strut 120 are such that central axis 112 of power-plant case section 110 is in a substantially vertical orientation when rotary strut foot 122, fixed support strut foot 132, and secondary strut foot 142 all contact supporting surface 190. It should be appreciated that the relationships between the lengths of secondary strut 140, fixed support strut 130, and rotary strut 120 may also be set so that case section 110 is in a desired orientation (e.g., vertical, 15 degrees from vertical, 30 degrees from vertical, 45 degrees from vertical, etc.) when rotary strut foot 122, fixed support strut foot 132, and secondary strut foot 142 all contact supporting surface 190.

In an exemplary embodiment, rotatable power-plant case section 100 also includes one or more stabilizer 150 that is configured and positioned to maintain fixed support strut 130 and/or secondary strut 140 in its desired orientation relative to central axis 112. Accordingly, each stabilizer 150 is designed and attached so as to carry loads between two or more of power-plant case section 110, rotary strut 120, fixed support strut 130, and secondary strut 140.

In an exemplary embodiment, rotatable power-plant case section 100 also includes one or more lifting connector 160, which is attached to first flange 116 or fixed support strut 130 at or near midpoint 117 of first flange 116. Alternatively, lifting connector 160 may be attached directly to web 119. In an exemplary embodiment, lifting connector 160 is positioned at or near the intersection of web 119 and a plane that is perpendicular to central axis 112 and that passes through the center of gravity of rotatable power-plant case section 100. Lifting connector 160 is configured to accommodate application of a lifting force through attachment, via a tension member, to a hoist or another lifting apparatus. Accordingly, lifting member 160 is sufficiently strong to support the weight of rotatable power-plant case section 100.

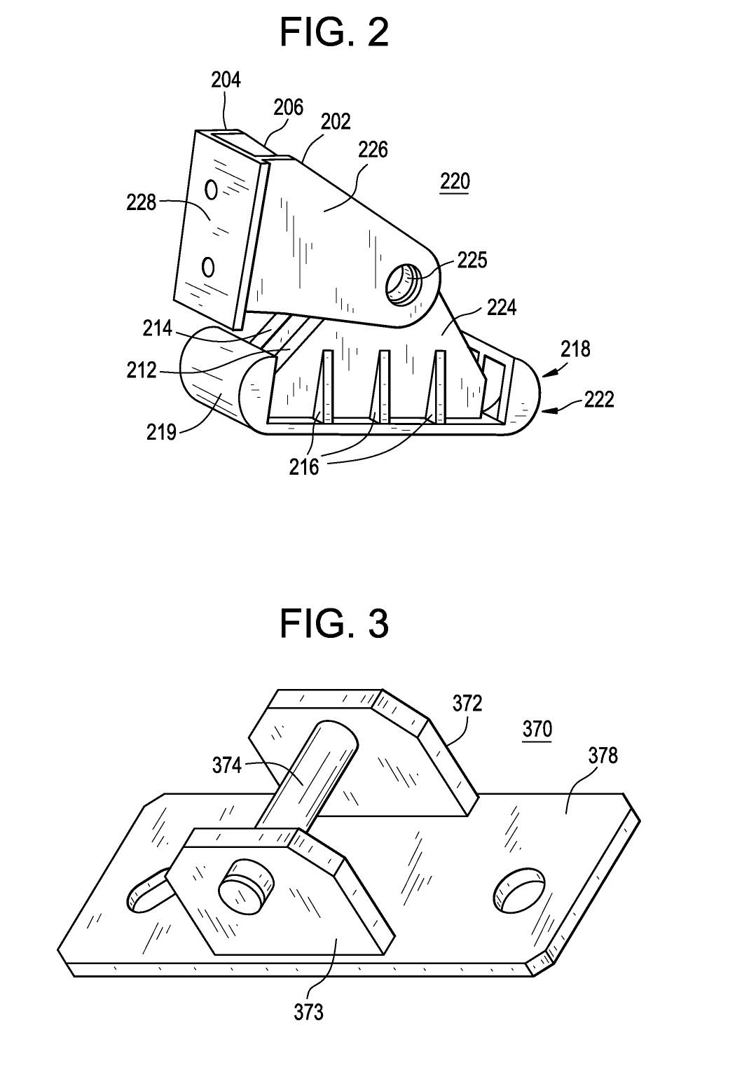

In an exemplary embodiment, rotatable power-plant case section 100 also includes one or more rotating connector 170, which is attached to second flange 113. Alternatively, each rotating connector 170 may be attached directly to web 119. Rotating connector 170 is positioned at a point on rotatable power-plant case section 100 such that a force applied to rotating connector 170 in a direction perpendicular to central axis 112 will produce a rotational moment about the center of gravity of rotatable power-plant case section 100. Each rotating connector 170 is configured to accommodate application of a rotating force through attachment of a rope, cable, chain or another tension member. Accordingly, rotating connector 170 is sufficiently strong to help support the weight of rotatable power-plant case section 100 and to bear the described rotating force. In one embodiment, as shown in FIG. 2, rotating connector 170 includes connector flange 178 for attaching rotating connector 170 to second flange 113. Rotating connector 170 also includes side rails 172, between which a rod 174 is supported. In use, a rope or other flexible tension member may be passed through rotating connector 170 and manipulated, either by hand or with the assistance of a manual or automatic device, such as a chain block, so as to apply the rotating force to rotatable power-plant case section 100 and thereby adjust its orientation.

In one aspect, a power-plant case section may be rotated by attaching at least one rotary strut, at least one fixed support strut, at least one lifting connector, and at least one rotating connector to the case section; applying a lifting force to the at least one lifting connector so as to raise the case section; and applying a rotating force to the at least one rotating connector so as to rotate the case section. When the case section has been rotated so that it occupies a desired orientation, the forces applied to the at least one lifting connector and the at least one rotating connector may be modulated so as to maintain the desired orientation while positioning the case section onto a supporting surface. It should be appreciated that tension members such as rope, cable, chain, and the like are used to apply the described lifting and rotating forces to the respective connectors. Each or all of the tension members may be coupled to any suitable force-providing mechanism such as a hoist, a crane, or a pulley. It should also be appreciated that the rotating force applied to the rotating connector may be supplied by any suitable means (e.g., a chain block) for manipulating the rotating force and thus the distance between, and/or relative heights of, the rotating connector and the hoist, crane, pulley, or another suitable anchor.

FIG. 2 is a drawing of an exemplary rotary strut as described herein. As shown in FIG. 2, rotary strut 220 includes a rotary strut base 224 and a rotary strut leg 226 that are attached to one another by rotary strut pin 225 so that rotary strut leg 226 may rotate about rotary strut pin 225. In an exemplary embodiment, rotary strut pin 225 is a hollow, cylindrical pin. Rotary strut leg 226 includes a rotary strut flange 228 with holes (as shown) or studs (not shown) that are positioned to facilitate attachment of rotary strut 220 to a first flange of a case section in a desired position and orientation. As shown in FIG. 2, rotary strut base 224 is attached to, and supported by, rotary strut foot 222. Rotary strut foot 222 may also incorporate a resilient and/or traction-enhancing material such as rubber to reduce slipping between rotary strut foot 222 and an adjacent supporting surface and to help prevent damage to the surface or to an attached case segment. Rotary strut foot 222 may be relatively large in area so as to distribute the weight it bears, and that weight may be transmitted to rotary strut base 224 via a plurality of members 216. Rotary strut foot 222 may also include curved nose 218 and heel 219 segments for improved safety. In an exemplary embodiment, rotary strut leg 226 comprises two plates 202, 204 that are parallel and separated by a block 206. Rotary strut base 224 similarly comprises two parallel plates 212, 214, which are mounted between plates 202, 204.

As shown in FIG. 3, an exemplary rotating connector 370 is configured to accommodate attachment of a rope or other tension member to help support the weight of a rotatable case part. In an exemplary embodiment, rotating connector 370 includes a connector flange 378 for attaching rotating connector 370 to a second flange of a case part. In one embodiment, rotating connector 370 includes a pair of side rails 372, 373, between which a rod 374 is supported. In use, a rope or other flexible tension member may be passed through rotating connector 370 and manipulated, either by hand or with the assistance of a manual or automatic device, to apply a force to rotating connector 370.

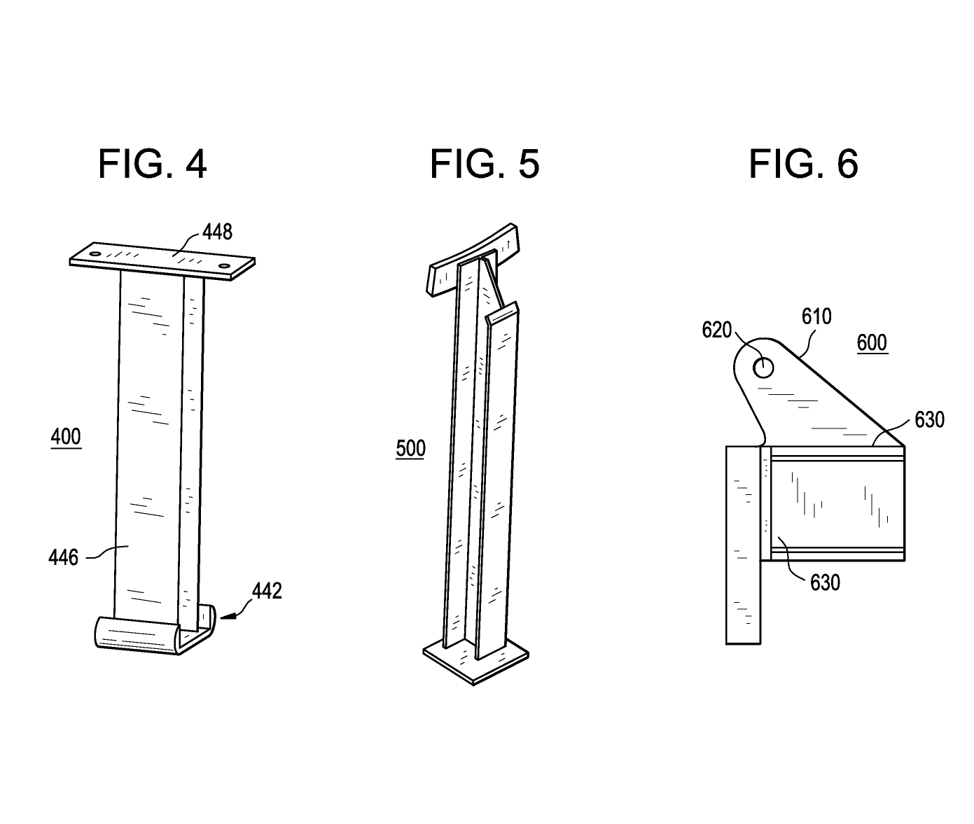

As shown in FIG. 4, an exemplary fixed support strut 400 is configured for attaching to and supporting the weight of a rotatable case part. At a first end, strut 400 includes a strut flange 448 to facilitate attachment of strut 400 to a flange of a rotatable case part. It should be appreciated that strut flange 448 may comprise PTFE or another similar non-stick material to resist causing damage to the flange at the point of attachment. At an opposing end, strut 400 includes a strut foot 442. Between strut foot 442 and strut flange 448, strut 400 includes a strut leg 446, which comprises an I-shaped cross section with an integral stiffening web (not shown). Strut leg 446 is configured to help support a case section when fully rotated into a desired orientation, such as a vertical orientation. In an exemplary embodiment, the length of strut 400 is such that strut foot 442 contacts a supporting surface as attached case section is in a substantially vertical orientation.

As shown in FIG. 5, an exemplary stabilizer 500 is configured to attach to two or more struts so as to maintain the position and/or orientation of each strut. Stabilizer 500 includes an I-shaped cross-section with mounting flanges at its two ends.

As shown in FIG. 6, an exemplary lifting connector 600 comprises a plate 610 that defines a hook receiver 620, thus being configured to accommodate attachment of a tension member. In this embodiment, lifting connector 600 and configured for attachment to a strut via a flange 630. Lifting connector 600 is sufficiently strong to support the weight of a rotatable case part. In an exemplary embodiment, flange 630 may be configured for attachment to a first flange of a rotatable case part. To accomplish that, a pattern of holes or studs in flange 630 matches a complementary hole or stud pattern in the first flange. Flange 630 may also be configured for attachment directly to a web of a rotatable case part.

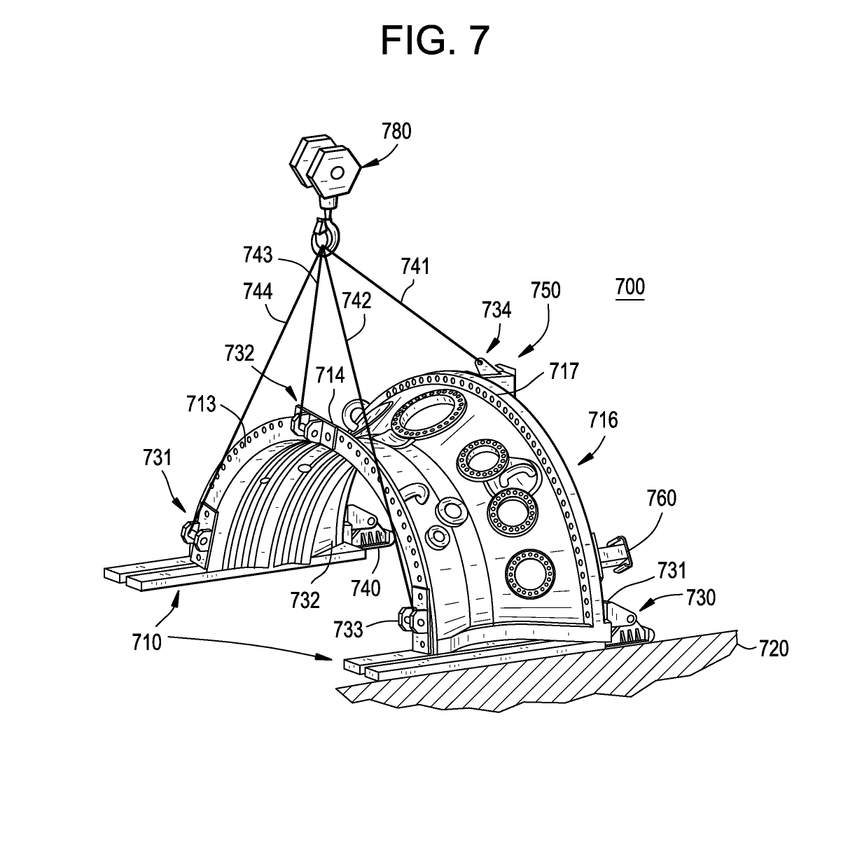

As shown in FIG. 7, an exemplary rotatable power-plant case section 700 is shown in a horizontal orientation. Rotatable power-plant case section 700 is supported by a pair of wooden skids 710 on supporting surface 720. Rotatable power-plant case section 700 includes three rotating connectors 731, 732, and 733 and one lifting connector 734. Rotating connector 732 is attached to second flange 713 at or near front flange midpoint 714. Lifting connector 734 is attached to first flange 716 at or near first flange midpoint 717. Rotary struts 730 and 740 are attached to endpoints 731, 732 of first flange 716. Rotary struts 730 and 740 are positioned so that their axes of rotation are parallel and their feet are closely proximate or touching supporting surface 720. A hoist supports tension members 741, 742, 743, and 744, which extend to rotating connectors 731, 732, and 733 and lifting connector 734. Rotatable power-plant case section 700 also includes a fixed support strut 750 attached to first flange 716 at or near midpoint 717. Secondary strut 760 is also attached to first flange 716. A third strut (not shown) is attached to first flange 716 on the other side of midpoint 717 from secondary strut 760.

To facilitate rotation of rotatable power-plant case section 700, an operator may use a mobile crane, a chain block, a pulley system, or another hoist 780 so as to apply a lifting force to raise the rotatable power-plant case section 700 above the wooden skids 710. The operator may also manipulate tension members 741, 742, 743, and 744 using a chain block, come-along, or other known apparatus, and may thereby apply a rotating force to rotating connectors 731, 732, and 733 so as to rotate power-plant case section 700 into a desired orientation, such as a vertical orientation where the feet of each strut is contacting the supporting surface 720. It should be noted that a chain block can be effective for slow manipulation of the rotating force, and thus the slow manipulation of the orientation of case part 710.

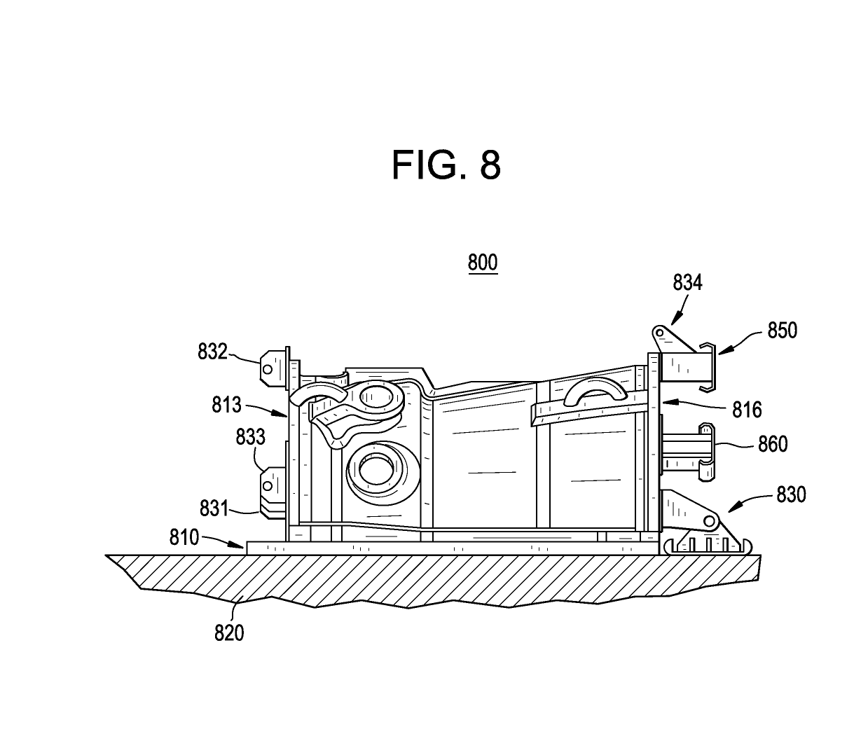

As shown in FIG. 8, an exemplary rotatable power-plant case section 800 is supported in a horizontal orientation by a wooden skid 810 on supporting surface 820. Rotatable power-plant case section 800 includes three rotating connectors 831, 832, and 833 and one lifting connector 834. Rotating connectors 831, 832, and 833 are attached to second flange 813, and lifting connector 834 is attached to first flange 816. Rotary strut 830 is attached to first flange 816. Rotatable power-plant case section 800 also includes a fixed support strut 850 attached to first flange 816 at or near its midpoint. Secondary strut 860 is also attached to first flange 816.

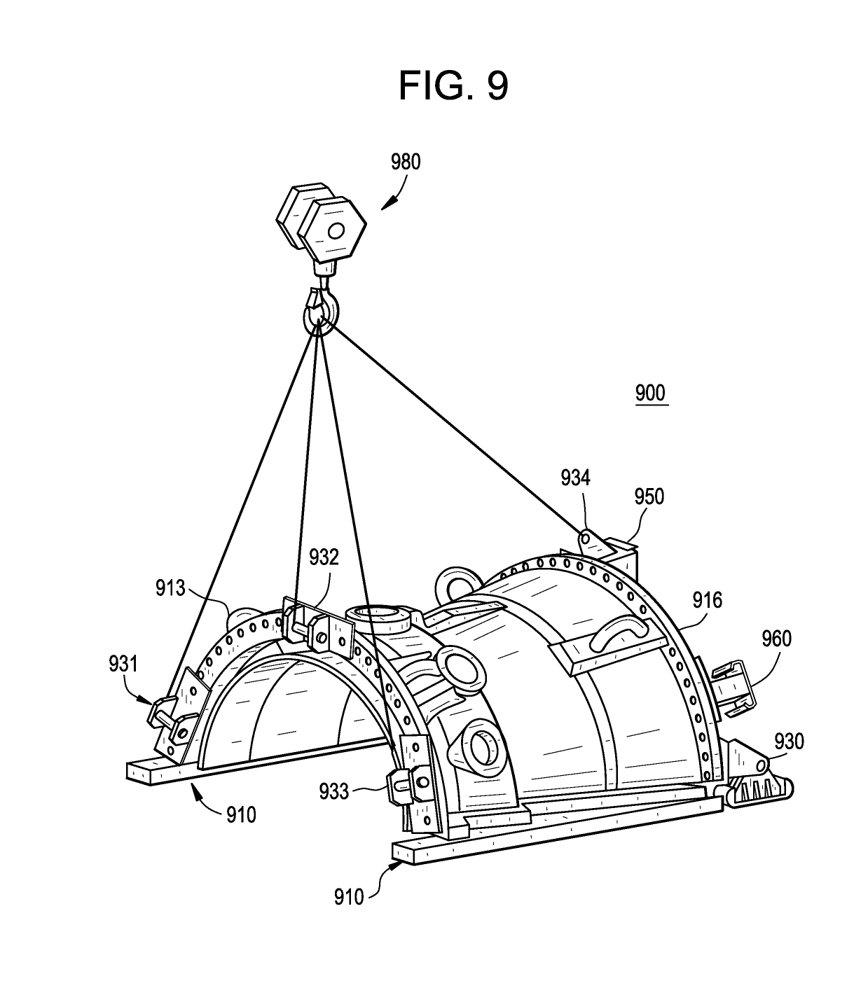

As shown in FIG. 9, an exemplary rotatable power-plant case section 900 is supported in a horizontal orientation by a pair of wooden skids 910 as well as a number of tension members that couple hoist 980 to rotating connectors 931, 932, and 933 and to lifting connector 934. Rotating connectors 931, 932, and 933 are attached to second flange 913, and lifting connector 934 is attached to first flange 916. Rotary strut 930 is attached to an end of first flange 916. Rotatable power-plant case section 900 also includes a fixed support strut 950 attached to first flange 916 at or near its midpoint. Secondary strut 960 is also attached to first flange 916.

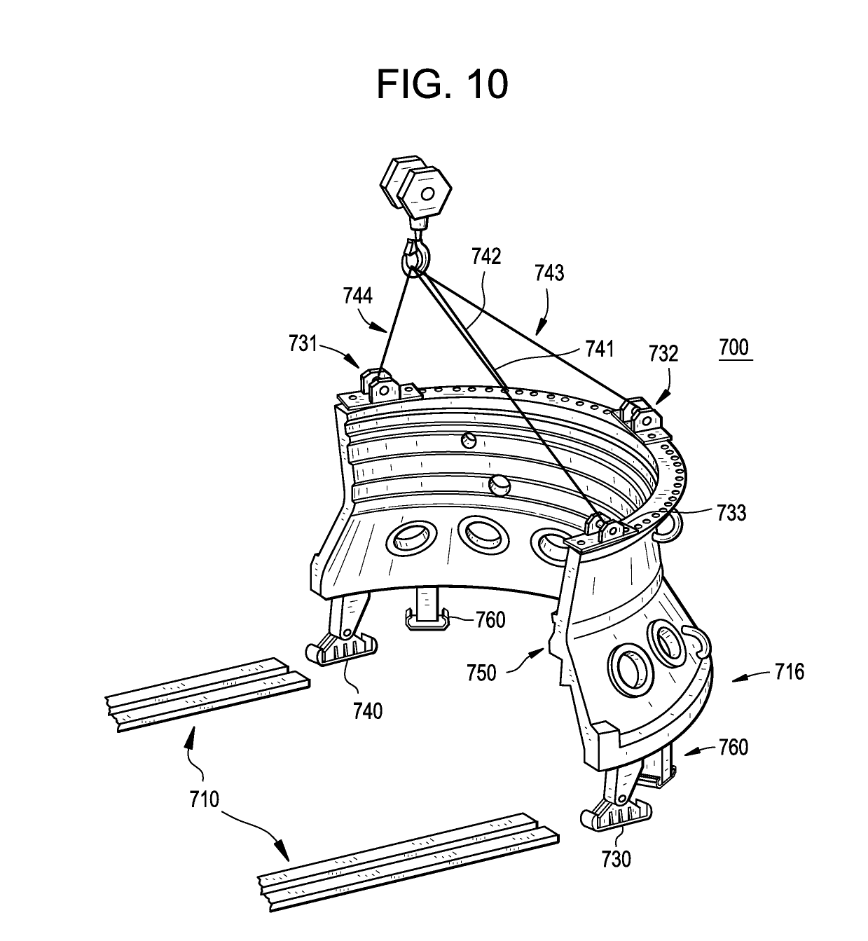

As shown in FIG. 10, an exemplary rotatable power-plant case section 700 is shown in a substantially vertical orientation. Rotatable power-plant case section 700 has been rotated so that it no longer lies upon the pair of wooden skids 710, instead being supported by rotary struts 730 and 740, fixed support strut 750, and secondary struts 760, all of which are attached to first flange 716. Three rotating connectors 731, 732, and 733 remain in connection with tension members 742, 743, and 744 while tension member 741, which had been applying tensile force to lifting connector 734, has been released. Axis of rotation of rotary struts 730 and 740 remain parallel.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A rotatable power-plant case section comprising:
a web disposed between a first flange and a second flange,
at least one rotary strut attached to the first flange,
at least one fixed support strut attached to the first flange,
at least one lifting connector for applying a force to raise the rotatable power-plant case section, and
at least one rotating connector for applying a force to rotate the rotatable power-plant case section.

2. A rotatable power-plant case section as in claim 1, comprising two rotary struts attached to the first flange.

3. A rotatable power-plant case section as in claim 2, wherein the rotary struts are positioned and configured to rotate about a single axis.

4. A rotatable power-plant case section as in claim 2, wherein a first of the rotary struts is positioned and configured to rotate about a first axis of rotation, and a second of the rotary struts is positioned and configured to rotate about a second axis of rotation, and wherein the first axis of rotation is parallel to the second axis of rotation.

5. A rotatable power-plant case section as in claim 1, wherein the fixed support strut is attached to the first flange near its midpoint.

6. A rotatable power-plant case section as in claim 1, comprising two fixed support struts, each being attached to the first flange on opposite sides of a midpoint of the first flange.

7. A rotatable power-plant case section as in claim 1, wherein the case section defines a central axis, and wherein a length of the fixed support strut enables the central axis to be oriented vertically when both the fixed support strut and the rotary strut contact a supporting surface.

8. A rotatable power-plant case section as in claim 1, comprising a single fixed support strut and two secondary struts.

9. A rotatable power-plant case section as in claim 1, wherein the fixed support strut is oriented substantially parallel to a central axis of the rotatable power-plant case section.

10. A rotatable power-plant case section as in claim 1, comprising two or more rotating connectors attached to the second flange for rotating the rotatable power-plant case section.

11. A rotatable power-plant case section as in claim 10, wherein two of the rotating connectors are attached to the second flange at ends of the second flange.

12. A rotatable power-plant case section as in claim 1, comprising three or more rotating connectors attached to the second flange for rotating the rotatable power-plant case section.

13. A rotatable power-plant case section as in claim 1, wherein the rotating connector is attached to the second flange at a midpoint of the second flange.

14. A rotatable power-plant case section as in claim 1, wherein the lifting connector is attached to the first flange at a midpoint of the first flange.

15. A rotatable power-plant case section as in claim 1, wherein the lifting connector is attached to the fixed support strut.

16. A rotatable power-plant case section as in claim 1, wherein a cross section of the fixed support strut is I-shaped.

17. A rotatable power-plant case section as in claim 1, wherein the rotating connector comprises one or more rods supported between a pair of plates.

18. A rotatable power-plant case section as in claim 1, wherein the lifting connector is attached to the web.

19. A rotatable power-plant case section as in claim 1, wherein the lifting connector is attached to the first flange, and the rotating connector is attached to the second flange.

20. A method for rotating a power-plant case section comprising:
attaching at least one rotary strut, at least one fixed support strut, at least one lifting connector, and at least one rotating connector to a power-plant case section,
applying a lifting force to the lifting connector so as to raise the case section, and
applying a rotating force to the rotating connector so as to rotate the case section to a desired orientation.
